(19) United States
(12) Patent Application Publication
(10) Pub. No.: US 2007/0169706 A1
(43) Pub. Date: Jul. 26, 2007

(54) Window support

(75) Inventors: Douglas Vagedes, Union, KY (US); Ivan Kingsley, Aurora (CA)

Correspondence Address: WOOD, HERRON & EVANS, LLP, 2700 CAREW TOWER, 441 VINE STREET, CINCINNATI, OH, 45202, US

(73) Assignee: United Ware Corporation, Union, KY (US)

(21) Appl. No.: 11/338,277

(22) Filed: Jan. 24, 2006

(51) Int. Cl. A01K 61/02

(52) U.S. Cl. 119/57.8

(57) ABSTRACT

A window support for a device such as a bird feeder, bird house, or planter, includes a rod with suction cups adapted to attach to a window pane. The support extends outwardly from said suction cups and downwardly, rigidly supporting the device relative to a window pane. This keeps the device from swinging against the window.

### BACKGROUND OF THE INVENTION

It is often desirable to support planters, bird feeders, or the like, in a location viewable from the inside of a building. Bird houses and bird feeders are commonly located closed to a home to allow individuals to see the birds either nesting or feeding at the bird device. The closer the device is to the house, the easier it is for the homeowner to view the birds.

Some bird feeders and bird houses can actually be attached to a window. Generally, these devices attach either to the frame of the window or to the window pane itself, and simply hang in front of the window. When the wind blows the bird device swings and bangs against the window. This noise is unpleasant and, further, it disturbs the birds and can cause a bird feeder to lose bird feed.

### SUMMARY OF THE INVENTION

The present invention is premised on the realization that a device such as a bird feeder or a bird house, or a planter, can be attached to a window in such a manner that it cannot swing or bang against the window. More particularly, the device is attached to a window using a rod attached to a window with suction cups. The rod extends outwardly away from the window downwardly, and supports the device rigidly in front of the window. Preferably, the device attaches to the upper sash of a double hung or single hung window permitting the bird feeder to be removed for cleaning or refilling.

The objects and advantages of the present invention will be further appreciated in light of the following detailed description and drawings, in which:

### BRIEF DESCRIPTION OF THE DRAWINGS

FIG. 1 is a perspective view of the present invention;

FIG. 2 is a exploded perspective view, partially broken away;

FIG. 3 is an alternate embodiment of the device as shown in FIG. 2;

FIG. 4 is an exploded view partially broken away of an alternate embodiment;

FIG. 4A is a cross sectional view taken at line 4A-4A of FIG. 4;

FIG. 5 is an exploded view of the present invention used to support a planter;

FIG. 5A is a cross sectional view taken at line 5A-5A of FIG. 5; and

FIG. 6 is a perspective view of an alternate embodiment of the present invention.

### DETAILED DESCRIPTION OF THE INVENTION

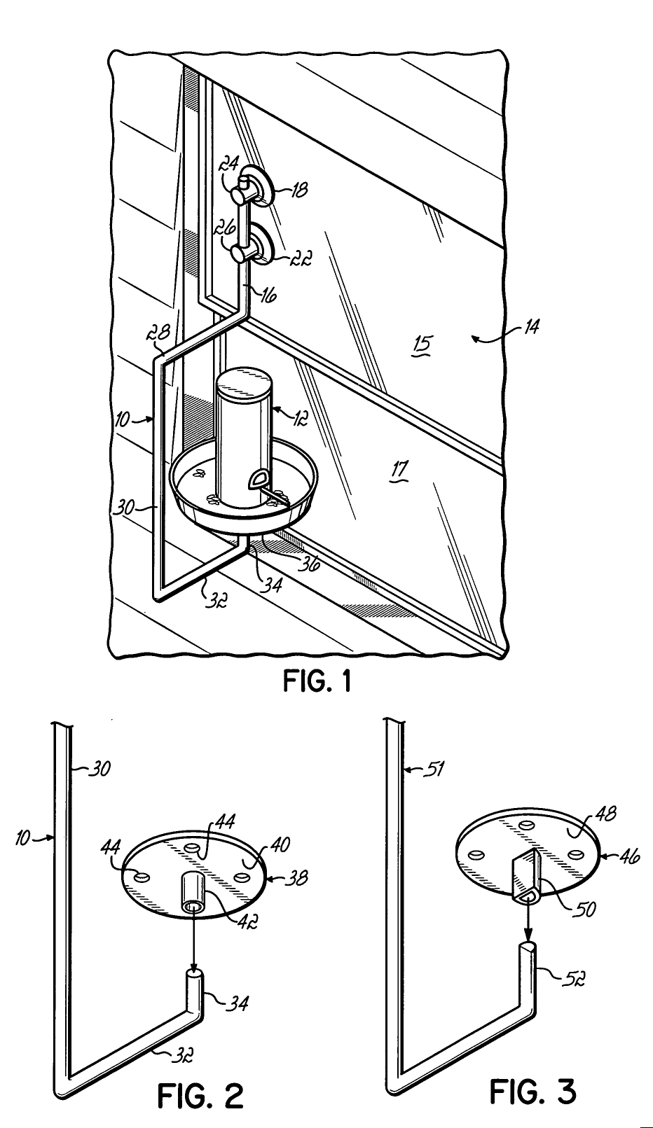

As shown in FIG. 1, a support 10 attaches to a window pane 14 and supports a bird feeder 12 in front of the lower sash 17. For purposes of the present invention, the support 10 can be used to support any device, including bird feeders and bird houses, planters, and the like.

The support 10 is a rigid rod which can be formed from any material that can be formed into the desired shape and is rigid and adequately supports the device 12. Preferably, the support 10 is a metal rod or tube made out of a relatively light metal such as aluminum, or the like. The rod 10 includes an upper end 16 which attaches to suction cups 18 and 22. Each suction cup 18 and 22 has a post portion 24 and 26 respectively, extending outwardly from the suction cup. The upper portion 16 of support 10 extends through holes in these posts forming a compression fit and fixing the rod in position relative to the suction cups. The suction cups are made of a flexible plastic.

The support 10 further includes an outwardly extended portion 28 which extends away from the upper sash 15 and a downwardly extended portion 30 connected to an inwardly extended portion 32 which, in turn, connects to an upwardly extended mounting portion 34. Mounting portion 34 extends to the bottom 36 of device 12.

More particularly, as shown in FIGS. 2 and 3, the mounting portion 34 may attach to a mounting bracket 38. Mounting bracket 38 includes a flange portion 40 and a central tube or mounting member 42. Screw holes 44 through the flange 40 allow the bracket 38 to attach to the bottom of the bird feeder or planter. As shown, the central tube 42 simply fits over the mounting portion 34 of support 10, fixing the bird feeder to the mounting portion.

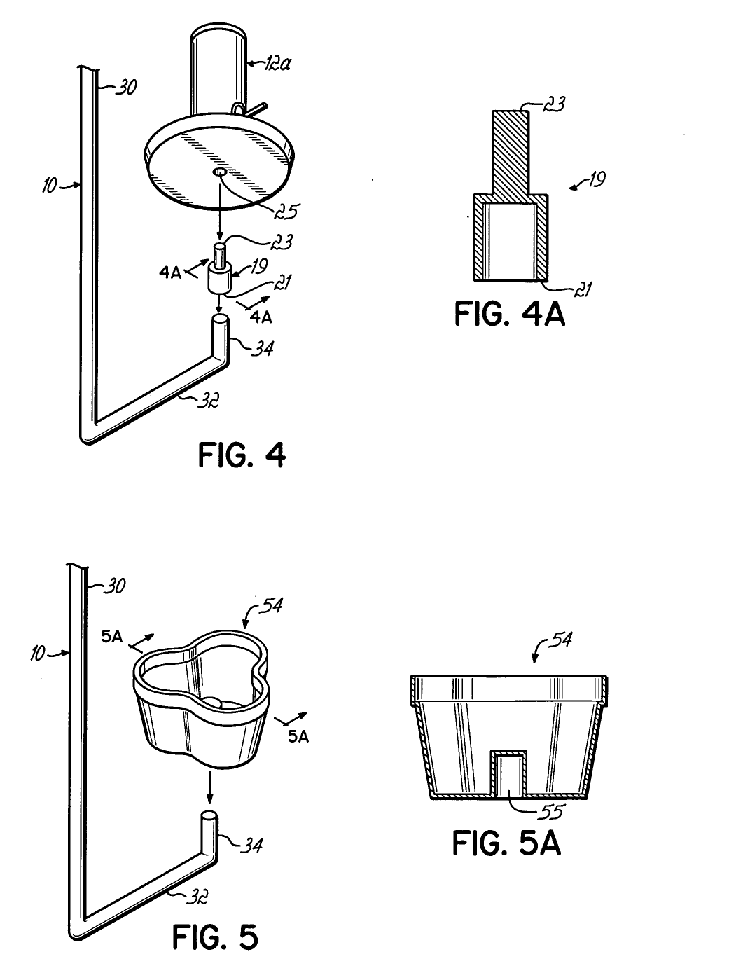

The support 10 can be attached directly to the bottom of the feeder using any attachment mechanism. For example, the tube 42 can be integrally formed in the bottom of the device. As shown in FIGS. 4 and 4A, an adapter 19 can be used to attach the device to an existing opening 25 in a bird feeder 12a or other device. The adapter 19 has one end 21 configured to fit over end 34 and a second end 23 adapted to fit into the pre-existing mounting hole 25 in bird feeder 12a.

As shown in FIG. 1, the bird feeder 12 is fixedly mounted relative to the upper window sash 15 and spaced from the sash. As shown, it is easy to remove the bird feeder 12 to add additional feed by simply lifting the bird feeder 12 off of the tip portion 34. With the suction cups attached to the upper sash 15, the bird feeder 12 is held forward of the lower sash 17. Thus, one can simply raise the lower sash 17, providing access to the bird feeder 12. The feeder remains stationary when lower sash 17 is opened.

FIG. 3 shows an alternate embodiment of the support and mounting bracket. In this embodiment, the mounting bracket 46 includes a flange 48 and a central keyed tubular portion 50. The support 51 includes a tip portion 52 which mates with the central keyed tube 50 of bracket 46. When the bird feeder 12 is placed on the support 51, its location will remain the same relative to the support 51 and, thus, the window, due to the inter fitting of the keyed mounting bracket 46 and tip portion 52.

As shown in FIG. 5, the support 10 can also be used to support a planter 54. The planter 54 includes structure to attach to end 34 of support 10. As shown in FIG. 5A, the planter 54 includes a central cavity 55 which fits onto end 34. A bracket 38 as shown in FIG. 2 can also be used. This allows a planter 54 to be mounted in front of the lower sash 17 of a window. In this position, it is easy to open the lower sash 17 to water or prune plants in the planter. This is ideal for herbs.

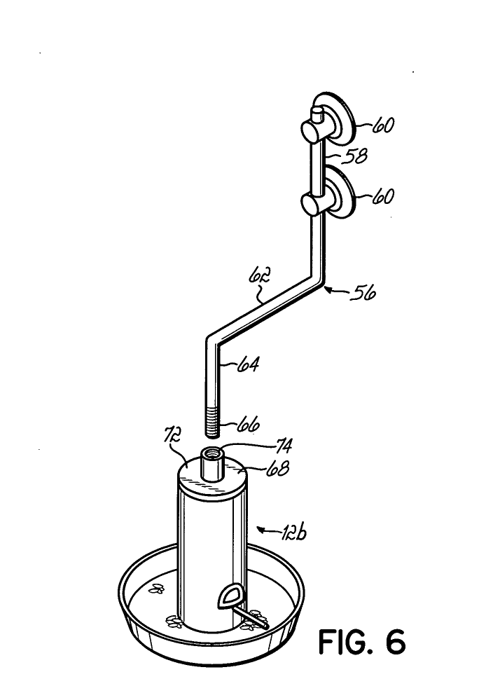

FIG. 6 shows another alternate embodiment of the present invention. In this embodiment, a support 56 includes an upper portion 58 and suction cups 60, fixedly attached to the upper portion 58 of the support 56. The support 56 further includes an outwardly extended portion 62 and a downwardly extended end 64. The downwardly extended portion 64 includes an externally threaded end 66 which attaches to a mounting flange 68. The mounting flange 68 includes a flange portion 72 attached to the bird feeder 12b and an internally threaded mounting member 74. In this embodiment, the suction cups 60 are simply attached to the window pane 14 as with the embodiment shown in FIG. 1. The bird feeder 12b is attached to the support 56 with the mounting flange 68 screwed into the bottom portion 66 of the support 58.

Thus, in the embodiments shown in either FIG. 1 or FIG. 6, the bird feeder or other device such as a bird house, planter, or the like, is attached to the window pane and fixed relative to the window pane so that it cannot move and will not swing, banging up against the window. This allows the home owner to view birds on the bird device from close up. Because the device does not swing, the birds will be more secure. This also provides an unobstructed view of the birds at the feeder. Further, bird feed will not be lost due to the bird feeder striking the window. If the device is a planter, the support makes it easy to tend to the plants. This is easy to install from the inside of the house. Further, the bird house or feeder can be easily removed for cleaning, refilling, or changing the type of feeder for the season.

This has been a description of the present invention along with the preferred method of practicing the present invention. However, the invention itself should only be defined by the appended claims, WHEREIN

We claim:

1. A combination of a support and an outdoor device:
said support comprising a rod fixed to a suction cup configured to attach to a window pane, said rod extended outwardly and downwardly relative to said suction cup;
a bottom portion of said rod fixedly attached to said device thereby rigidly supporting said device relative to said suction cup.

2. The combination claimed in claim 1 wherein said rod attaches to a top of said device.

3. The combination claimed in claim 1 wherein said rod attaches to a bottom of said device.

4. The combination claimed in claim 1 wherein said device has a keyed opening and said rod has an end portion configured to mate with said keyed opening.

5. The combination claimed in claim 1 wherein said device is a bird house.

6. The combination claimed in claim 1 wherein said device is a bird feeder.

7. The combination claimed in claim 1 wherein said device is a planter.

8. The combination claimed in claim 2 wherein said support has an externally threaded end and said device has an internally threaded member configured to attach to said threaded end.

9. The combination claimed in claim 1 wherein said support includes a plurality of suction cups fixed axially relative to said support.

10. The combination claimed in claim 9 wherein said support includes an upper rod member that extends through posts in said suction cups.

11. The combination claimed in claim 10 wherein said suction cups are attached to an upper sash of a window and said device is supported in front of a lower sash of said window.
